(19) United States
(12) Patent Application Publication
(10) Pub. No.: US 2010/0121527 A1
(43) Pub. Date: May 13, 2010

(54) INFORMATION PROCESSING APPARATUS

(75) Inventor: Toshiyuki Namba, Tokyo (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi, Aichi (JP)

(21) Appl. No.: 12/531,560

(22) PCT Filed: May 7, 2008
(86) PCT No.: PCT/JP2008/058492

§ 371 Date: Sep. 16, 2009

(30) Foreign Application Priority Data
May 10, 2007 (JP) 2007-126056

(51) Int. Cl. G06F 7/00; G06F 17/30

(52) U.S. Cl. 701/36; 707/705; 707/E17.001

(57) ABSTRACT

An onboard information retrieval apparatus 100 for retrieving information based on a word inputted via manual or voice input by an operator includes a travel environment condition detecting unit 4 for detecting a travel environment condition; an ambiguity tolerance determination unit 10 for determining a tolerance level for ambiguity in the inputted word based on the travel environment condition detected by the travel environment detecting unit 4; and an information retrieval unit 11 for retrieving the information in accordance with the tolerance level determined by the ambiguity tolerance determination unit 10.

### TECHNICAL FIELD

The present invention relates to an onboard information retrieval apparatus for retrieving and displaying information corresponding to a manual or voice input entered by an operator of a vehicle. Particularly, the invention relates to an onboard information retrieval apparatus in which tolerance to ambiguity of the input from the operator is varied depending on vehicle travel environment conditions.

### BACKGROUND ART

Conventionally, onboard electronic devices for vehicles are known in which permitted input operations or displayed information are limited, or the speed of reading of a voice guidance is changed depending on vehicle travel environment (see Patent Document 1, for example).

For example, in such an onboard electronic device, a manual input that has been accepted is rejected, or certain information that has been displayed is turned off as the vehicle speed increases.

Alternatively, certain information that has been displayed is replaced with a voice guidance with a slowed reading speed so that the driver can catch up with the voice guidance without concentrating too much on an operation on a display screen.

A navigation apparatus is also known in which a destination setting operation is prohibited when the distance to a vehicle travelling in front is smaller than a predetermined value (see Patent Document 2, for example).

A touch-type input apparatus is also known in which the size of software buttons (operated via a touch panel) displayed on a display is increased when the vehicle is traveling, compared to when the vehicle is stationary, or touch input in a certain area of the touch panel is invalidated when the vehicle is running (see Patent Document 3, for example).

The devices according to Patent Documents 2 and 3 are designed, as is the apparatus taught in Patent Document 1, to prevent the driver from taking too much time or paying too much attention for operations on the display screen when the vehicle is travelling.

A display control apparatus for vehicles is also known (see Patent Document 4, for example) in which screens that are linked with one another using a tree structure are displayed one by one. The operator is prompted to select a menu item displayed on each screen over multiple stages, in order to eventually activate a specific function of onboard equipment, such as a navigation system, an audio unit, or a communications unit, wherein the number of the stages is changed depending on the vehicle travel status.

In this display control apparatus for vehicles, when drive load is high and it is necessary for the driver to not pay too much attention for operations on the display screen, the number of the required stages is reduced so that the desired function of the onboard device can be activated more quickly.
Patent Document 1: Japanese Laid-Open Patent Application No. 2001-33256
Patent Document 2: Japanese Laid-Open Patent Application No. 11-353589
Patent Document 3: Japanese Laid-Open Patent Application No. 2006-29917
Patent Document 4: Japanese Laid-Open Patent Application No. 2004-251756

### DISCLOSURE OF THE INVENTION

### Problem to be Solved by the Invention

In these apparatuses or devices according to Patent Documents 1 to 3, predetermined input operations are rejected once the travel environment assumes a predetermined condition. Thus, unless the predetermined condition as the basis for such determination is appropriately set, input operation may be excessively limited, thus detracting from user friendliness.

In the display control apparatus for vehicles according to Patent Document 4, although the driver's input operations are not completely barred when the travel environment falls under a predetermined condition, the document does not teach or suggest the selection of which menu items is omitted to perform which function of what onboard device. Thus, the operability of the disclosed apparatus cannot be evaluated.

In view of the foregoing, it is an object of the present invention to provide an onboard information retrieval apparatus that limits input operation depending on a travel environment condition in order that the driver does not concentrate too much on an operation on a display screen, while maintaining an appropriate level of operability.

### Means of Solving the Problem

In order to achieve the aforementioned object, according to a first embodiment of the present invention, an onboard information retrieval apparatus for retrieving information based on a manual input or a voice input made by an operator includes a travel environment condition detecting unit configured to detect a travel environment condition; an ambiguity tolerance determination unit configured to determine a tolerance level for ambiguity in the manual input or the voice input, based on the travel environment condition detected by the travel environment detecting unit; and an information retrieval unit configured to retrieve the information in accordance with the tolerance level determined by the ambiguity tolerance determination unit.

In a second embodiment, the ambiguity tolerance determination unit changes the amount of input that can be accepted via the manual input in accordance with the tolerance level determined by the ambiguity tolerance determination unit.

In a third embodiment, the onboard information retrieval apparatus further includes a display control unit configured to control the number of letters in a displayed message by modifying the expression of the message.

In a fourth embodiment, the onboard information retrieval apparatus further includes a voice output control unit configured to control the degree of detail or the rate of output of a voice guidance based on the travel environment condition detected by the travel environment condition detecting unit.

In a fifth embodiment, the travel environment condition detecting unit detects the travel environment condition based on a vehicle speed, the time of day, an inter-vehicle distance, weather, or driver's biological information.

In a sixth embodiment, the ambiguity tolerance determination unit determines the tolerance level for ambiguity in the manual input and the tolerance level for ambiguity in the voice input separately.

### Effects of the Invention

The present invention provides an onboard information retrieval apparatus that can maintain an appropriate level of operability while limiting the input operation depending on the travel environment condition so that the driver do not concentrate too much on an operation on the display screen.

### BRIEF DESCRIPTION OF THE DRAWINGS

FIG. 1 is a block diagram of an onboard information retrieval apparatus according to the present invention;

FIG. 2 shows a drive load point conversion table;

FIG. 3 shows a required input item determination table;

FIG. 4A shows a first example of a display condition determination table;

FIG. 4B shows a second example of the display condition determination table;

FIG. 5 shows a destination setting screen;

FIG. 6 shows an example of an input in a destination search area; and

FIG. 7 shows a flowchart of an information retrieving process.

### DESCRIPTION OF THE REFERENCE NUMERALS

1 control unit
2 manual input unit
3 voice input unit
4 travel environment condition detecting unit
5 storage unit
6 display unit
7 voice output unit
10 ambiguity tolerance determination unit
11 information retrieval unit
12 display control unit
13 voice output control unit
50 drive load point conversion table
51 required input item determination table
52, 52A, 52B display condition determination table
100 onboard information retrieval apparatus
B1 to B13 software button
D destination setting screen
W message window

### BEST MODE OF CARRYING OUT THE INVENTION

In the following, preferred embodiments of the present invention are described with reference to the drawings.

### Embodiments

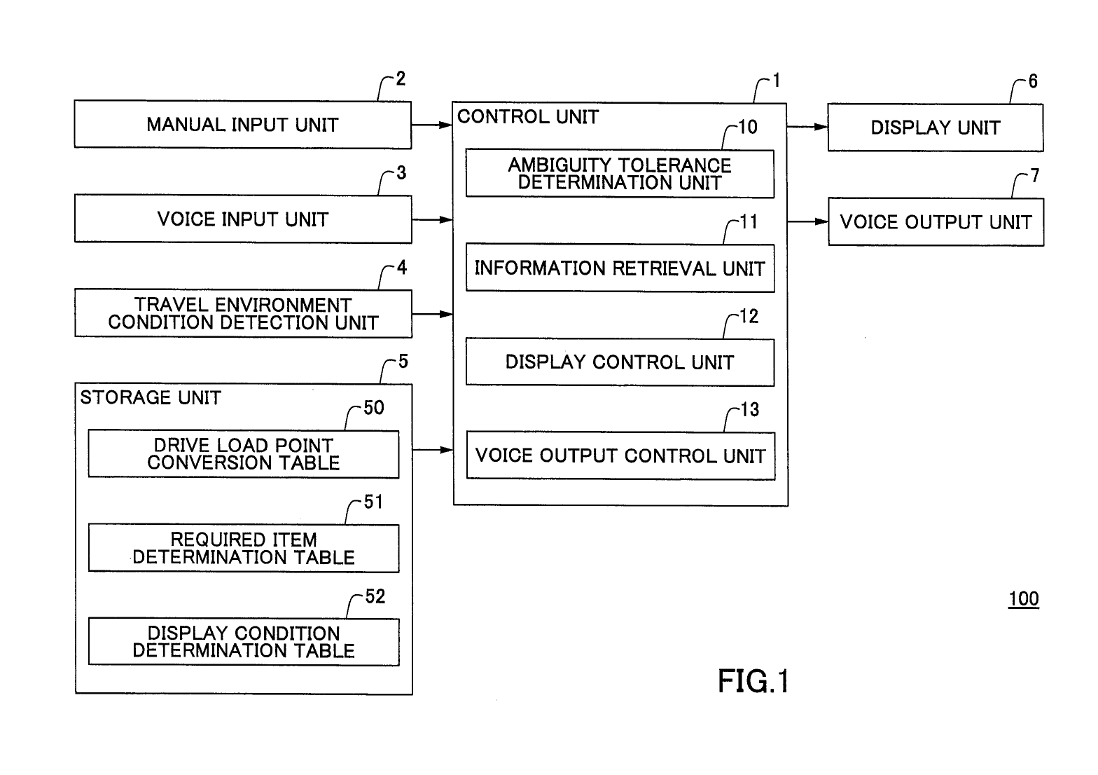

FIG. 1 is a block diagram of an onboard information retrieval apparatus according to an embodiment of the present invention. The onboard information retrieval apparatus 100 is an apparatus for retrieving information (such as the position of a destination) corresponding to an operator's manual or voice input (such as the destination's name) and outputting the retrieved information (by displaying a relevant map or a route, for example). The onboard information retrieval apparatus 100 includes a control unit 1, a manual input unit 2, a voice input unit 3, a travel environment condition detecting unit 4, a storage unit 5, a display unit 6, and a voice output unit 7.

The control unit 1 comprises a computer which may include a CPU (Central Processing Unit), a RAM (Random Access Memory), a ROM (Read Only Memory), and a voice recognition processor. In the ROM, there are stored programs corresponding to an ambiguity tolerance determination unit 10, an information retrieval unit 11, a display control unit 12, and a voice output control unit 13. The CPU executes processes corresponding to these individual units.

The voice recognition processor is configured to convert a voice that is inputted via the voice input unit 3 into text data. The voice recognition processor may identify the spoken content (such as the subject, the object, etc.) by analyzing the sentence structure of the text data obtained by voice conversion.

The manual input unit 2 is a device for manually inputting various information into the onboard information retrieval apparatus 100. The manual input unit 2 may include a touch panel, a touch pad (input device installed away from the display), a wireless remote controller, a joy-stick, and an escutcheon switch.

The voice input unit 3 is a device for inputting various information into the onboard information retrieval apparatus 100 via voice input. The voice input unit 3 may include a directional microphone for recognizing speech from only a predetermined direction, and a microphone set with a plurality of sound receiving units enabling the separation of speeches from multiple directions based on phase difference among the multiple sounds.

The travel environment condition detecting unit 4 is a sensor for detecting a travel environment condition. The travel environment condition detecting unit 4 may include a vehicle speed sensor, a steering angle sensor, an inter-vehicle distance sensor, a gradient sensor, and a rain sensor. A value obtained by each sensor is sent to the control unit 1 so that the control unit 1 can monitor the travel environment condition (such as an environment that demands a high drive load or a special attention), based on the degree of congestion of the road, the degree of complexity of the road (such as whether the road is flat or has a large number of curves), visibility, and the like.

The travel environment condition detecting unit 4 may enable the control unit 1 to monitor the travel environment condition based on the driver's vital signs (biological information) so that it can be determined whether the environment is one that makes the driver tense or complacent. In this case, the driver's vital signs may be detected by a heart rate sensor, a blood pressure sensor, a brain wave sensor, a pulse sensor, a perspiration sensor, and/or a myoelectric sensor.

The storage unit 5 is a device for storing various information, such as a drive load point conversion table 50, a required input item determination table 51, and a display condition determination table 52, as well as a dictionary database used by the voice recognition processor for converting voice data acquired via the voice input unit 3 into text data. The storage unit 5 may include a recording medium such as a hard disk or a DVD (Digital Versatile Disk).

The drive load point conversion table 50 is a table referenced by the ambiguity tolerance determination unit 10 described later for converting the values acquired by the various sensors in the travel environment condition detecting unit 4 into drive load points for the determination of the travel environment condition. The higher the drive load point, the higher the drive load.

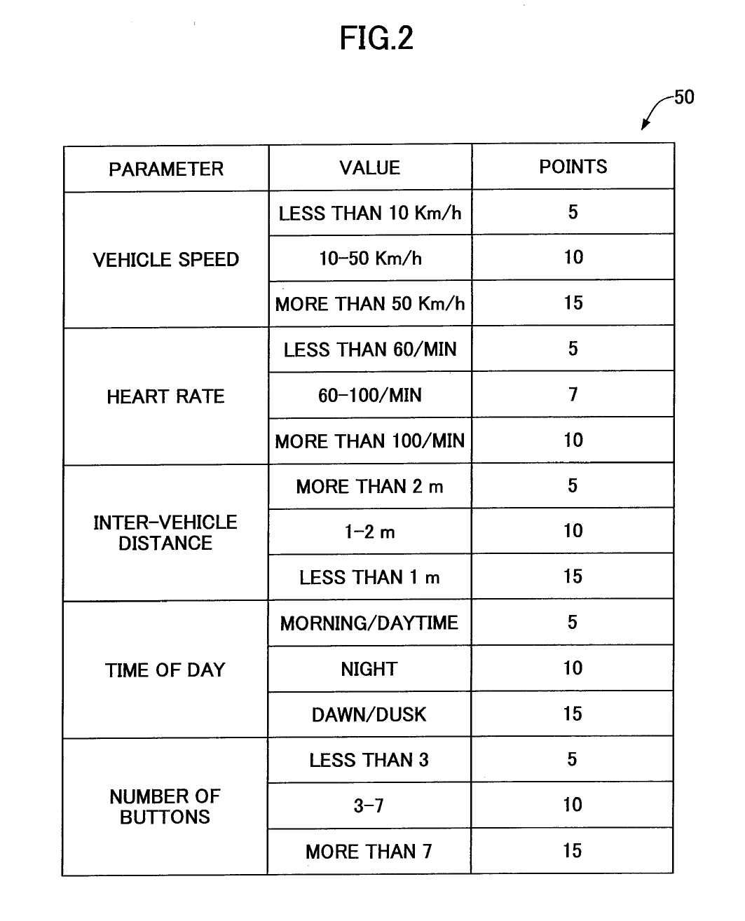

FIG. 2 shows an example of the drive load point conversion table 50. For example, when the vehicle speed is 60 km/h, the heart rate of the driver is 70 beats per minute, the inter-vehicle distance is 15 m, the time is 11 o'clock, and the number of buttons in the display screen is six, the total of the individual drive load points at that time is 42 (15+7+5+5+10).

The required input item determination table 51 is a table that is referenced by the ambiguity tolerance determination unit 10 as described below when determining whether the input of an item required for the start of a search can be omitted.

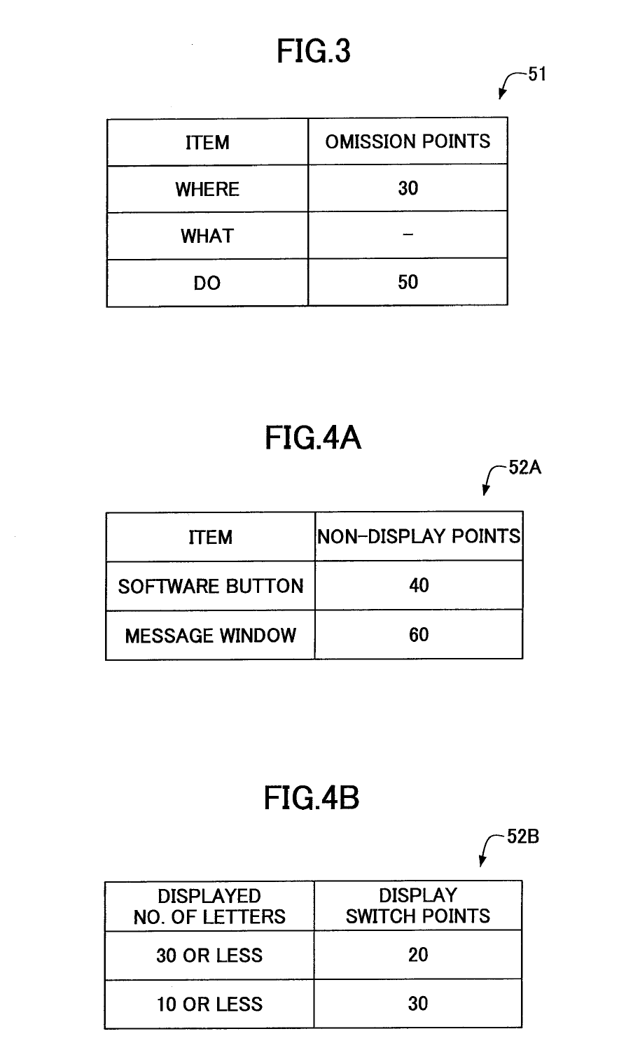

FIG. 3 shows an example of the required input item determination table 51. When the total drive load point is 30 or more, for example, the input item “Where (destination search area)” is eliminated from the required input items. When the total drive load point is 50 or more, for example, the input item “Do (activity content)” is eliminated from the required input item. It is seen from FIG. 3 that the input item “What (subject of activity)” cannot be eliminated from the required input items regardless of the total drive load point.

The display condition determination table 52 is a table that is referenced by the display control unit 12 as described below when determining which object (such as a software button, an icon, a display message, or the like) on each screen is to be displayed in what manner (such as by toning it down or hiding it).

FIG. 4A and FIG. 4B show examples of the display condition determination table 52. FIG. 4A shows that, when the total drive load point is 40 or more, software buttons on the screen are hidden or toned down. When the total drive load point is 60 or more, a displayed message on the screen is hidden or toned down. This is to ensure that the driver's attention is not attracted by such buttons or messages excessively when the drive load is high. It is also to enable the transmission of the minimum required information to the driver quickly.

FIG. 4B shows that, when the total drive load point is 20 or more, the length of a message displayed on the screen is limited to within 30 words. When the total drive load point is 30 or more, the length of a message displayed on the screen is limited to within 10 words. This is to ensure that more detailed information can be supplied to the driver when the drive load is low, and also so that necessary and sufficient information alone is conveyed to the driver when the drive load is high.

The display unit 6 is a device for displaying various information, such as a destination setting screen, electronic map data, an information search result and the like. The display unit 6 may include a liquid crystal display.

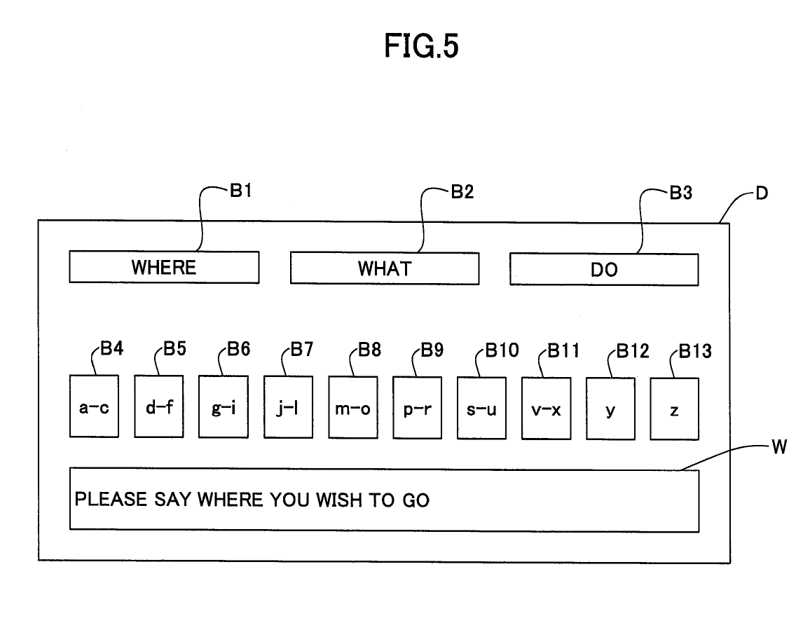

FIG. 5 shows an example of the destination setting screen displayed on the display unit 6. The destination setting screen D shows software buttons B1 to B13 and a message window W.

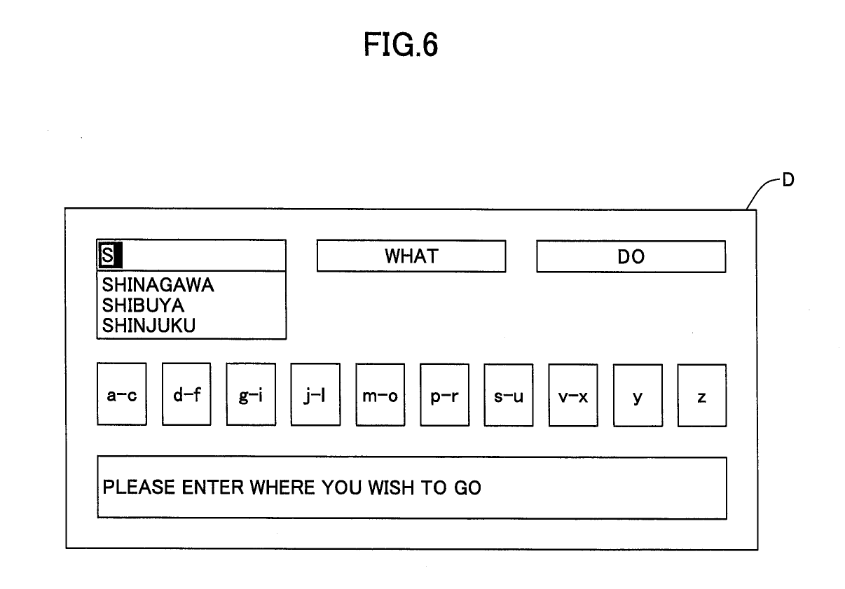

The software button B1 is a button for inputting a destination search area. The software button B1, when it is touch-operated, may pop up a text box for accepting a keyword (see FIG. 6). Such a text box may be popped up when a voice “Search area” is inputted via the voice input unit 3. Examples of the keyword indicating the destination search area are “Tokyo”, “Within 5 km”, and “Within 10 minutes”.

Similarly, the software button B2 is a button for inputting a subject of activity, such as “Chinese”, “Soccer”, or “Observatory”. The software button B3 is a button for the input of an activity content, such as “Eat”, “Watch”, or “Sightsee”.

The software buttons B4 to B13 are buttons for the input of a text. For example, pressing the software button B4 once inputs the letter “a”. Pressing the button B4 twice and three times input the letters “b” and “c”, respectively. The software buttons B5 to B13 function similarly.

For the duration of the pop-up display of the text box, the control unit 1 accepts text input via the software buttons B4 to B13 or voice input via the voice input unit 3.

The message window W defines a field for displaying a text of an appropriate operation guidance corresponding to the status in the destination setting screen D. For example, upon recognition of the pressing of the software button B1 or the voice “Search area”, the control unit 1 causes the text “Please say where you wish to go” to be displayed, thus providing a guidance as to what should be inputted.

The voice output unit 7 is a device for audibly outputting various information, such as a voice guidance as to a route for a destination, or a voice guidance supporting the operator's manual input or voice input. The voice output unit 7 may include an onboard speaker.

Hereafter, the various units in the control unit 1 are described.

The ambiguity tolerance determination unit 10 is a unit for determining the level of ambiguity in an input for starting a search. For example, the ambiguity tolerance determination unit 10 determines the tolerance level in accordance with the travel environment condition based on the output from the travel environment condition detecting unit 4.

It is now assumed that facilities for watching movies in Tokyo should be retrieved, and routes to those facilities should be presented. In this case, the ambiguity tolerance determination unit 10 determines the tolerance level of input ambiguity depending on the total drive load point, by referring to the required input item determination table 51 (The tolerance level varies depending on whether, for example: all of the items of the destination search area (“Tokyo”), subject of activity (“Movie”), and activity content (“Watch”) should be inputted; the input of the destination search area should be omitted (In this case, an area within the 5 km radius of the current location may be considered the search area, instead of “Tokyo”); or the input of the activity content (“Watch”) should be omitted (In this case, the activity content “Watch” may be surmised from the subject of activity “Movie”).

When the total drive load point is low, such as when the vehicle is not moving, for example, the ambiguity tolerance determination unit 10 may apply a stricter tolerance level regarding input ambiguity. For example, the ambiguity tolerance determination unit 10 instructs the information retrieval unit 11 to start a search only after all of the input items of the destination search area, subject of activity, and activity content have been entered.

Thus, when the drive load is low and the driver can take time in inputting the search conditions, the onboard information retrieval apparatus 100 demands the input of more precise search conditions, so that more finely selected search results can be outputted.

On the other hand, when the total drive load point is high, such as when the vehicle is running along a winding road, the ambiguity tolerance determination unit 10 increases the input ambiguity tolerance, so that the information retrieval unit 11 can start a search as long as the subject of activity is inputted to the exclusion of destination search area and activity content.

Thus, when the drive load is high and the driver cannot take sufficient time for the input of the search conditions, the onboard information retrieval apparatus 100 can output an adequate search result quickly in response to the manual or voice input of a smaller number of conditions.

In another embodiment, the ambiguity tolerance determination unit 10 may limit each of the input items of the destination search area, subject of activity, and activity content that can be manually inputted to a predetermined number of registered words when the total drive load point is high. Conversely, when the total drive load point is low, the ambiguity tolerance determination unit 10 may accept any desired words.

For example, the ambiguity tolerance determination unit 10 may have registered in advance words that can be manually inputted for each of the input items of destination search area, subject of activity, and activity content, grouped into three words or less, five words or less, and seven words or less, for example. The ambiguity tolerance determination unit 10 may then determine which group to use as a population depending on the total drive load point.

Thereafter, the ambiguity tolerance determination unit 10 may extract candidate words from the determined group and display them each time a letter of text is manually inputted (see FIG. 6), thus facilitating the driver's manual input (selection) of the desired word. If the desired word does not exist in the group, the manual input of that word is limited.

Further, the ambiguity tolerance determination unit 10 may change the time window for voice input depending on the total drive load point.

For example, the ambiguity tolerance determination unit 10 is configured to shorten the time interval in which it can accept voice input as the total drive load point increase so that only words can be recognized. The ambiguity tolerance determination unit 10 extends the time interval for accepting voice input as the total drive load point decreases so that an entire phrase or sentence can be recognized. Counting of the time interval for accepting voice input may start upon detection of the driver's speech.

Thus, when the drive load is high and therefore the input of search conditions should not be given a high degree of freedom (as it would take a longer input time), the onboard information retrieval apparatus 100 limits the number of times of manual input or the time window for voice input. In this way, a search result commensurate with the content of the input made within a smaller number of times of manual input or a shorter time window for voice input can be outputted quickly.

The information retrieval unit 11 is a device for retrieving information about the word inputted manually or via voice input. For example, when the destination search area is “Tokyo”, the subject of activity is “Baseball”, and the activity content is “Watch” in the destination setting screen D, the information retrieval unit 11 retrieves information about the location of a facility where baseball games can be watched in Tokyo (longitude, latitude, and altitude), open hours, fees, etc., and displays such information on the display unit 6.

When a tolerance level corresponding to the drive load is determined by the ambiguity tolerance determination unit 10 such that the inputs of destination search area and activity content are omitted, the information retrieval unit 11 may start the search upon entry of the subject of activity so that a search result can be quickly displayed on the display unit 6. When the time window for voice input is narrowed and only words can be accepted, the information retrieval unit 11 may start the search as soon as the voice input time window has elapsed so that a search result can be displayed on the display unit 6 quickly.

The display control unit 12 is a device for controlling the content of the image displayed on the display unit 6 based on the travel environment condition detected by the travel environment condition detecting unit 4. The display control unit 12 may tone down or even hide some objects depending on the total drive load point.

For example, the display control unit 12, by referring to the display condition determination table 52A shown in FIG. 4A, compares the non-display points as thresholds for hiding the display of messages or buttons in the message window W with the total drive load point associated with the current travel environment condition. If the total drive load point exceeds any of the non-display points, the display control unit 12 hides a relevant item in the message window W.

In another embodiment, the display control unit 12, by referring to the display condition determination table 52B shown in FIG. 4B, may acquire the display switch points that determine the maximum numbers of letters within the message window W. If the current total drive load point is 40, for example, the display control unit 12 changes the expression of the displayed message so that the number of letters within the message window W is ten or less, without changing the intended meaning of the displayed message. In this case, different display messages with the same meaning are registered in the storage unit 5 in advance.

The voice output control unit 13 is a device for controlling the content of voice guidance based on the travel environment condition detected by the travel environment condition detecting unit 4. The voice output control unit 13 may change the level of detail of the voice guidance or the rate of its output depending on the total drive load point associated with the current travel environment condition.

For example, the voice output control unit 13, so that the driver can perform manual or voice input smoothly without relying too much on the information displayed on the display unit 6, causes the voice output unit 7 to output a voice guidance regarding the limit placed on the manual input or voice input depending on the total drive load point. The voice guidance regarding such limit becomes more detailed as the total drive load point increases. Conversely, the voice guidance regarding the limitation is made more simplified as the total drive load point decreases.

The voice output control unit 13 may reduce the rate at which such voice guidance is outputted as the total drive load point increases.

Furthermore, the voice output control unit 13 may also produce a voice output regarding the reason for the change in the limit on manual input or voice input (For example, because the vehicle speed has changed).

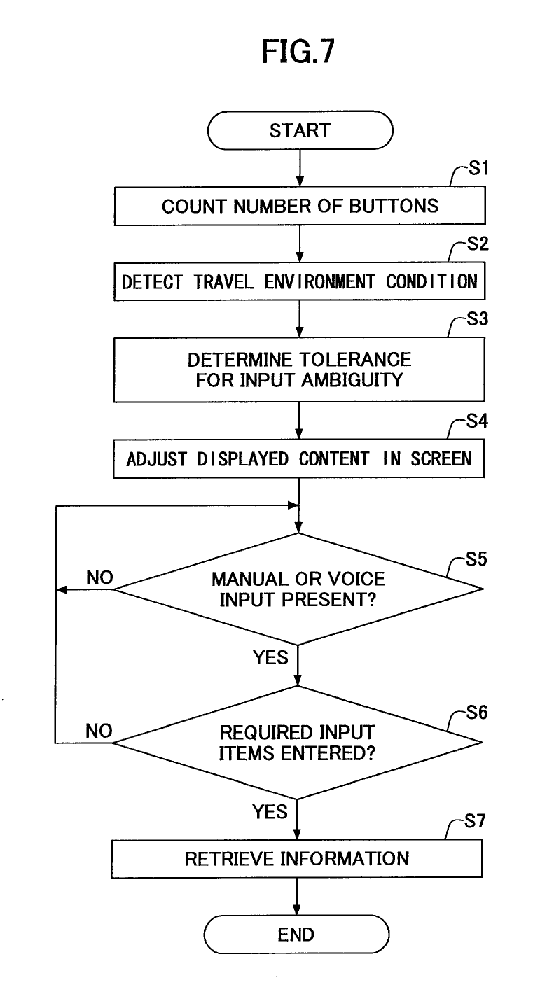

Referring to FIG. 7, a description is given of an operation (hereafter referred to as an “information retrieving process”) performed by the onboard information retrieval apparatus 100 for retrieving information based on a manual input or voice input that is limited depending on the travel environment condition. FIG. 7 is a flowchart of the information retrieving process.

First, the control unit 1 of the onboard information retrieval apparatus 100 counts the number of software buttons of which the destination setting screen D displayed on the display unit 6 is composed (step S1). This step is for acquiring the drive load point associated with the number of buttons. Specifically, based on a count result and by referring to the drive load point conversion table 50 (see FIG. 2), the control unit 1 acquires a drive load point corresponding to the number of buttons. The drive load point increases as the number of buttons increases, which means that the greater the number of buttons, the greater the probability of vacillation on the part of the driver when deciding on a software button, thus increasing the drive load.

Similarly, the control unit 1, based on the output of the travel environment condition detecting unit 4, acquires the drive load points for the vehicle speed, steering angle, and the driver's biological information, etc., and calculates their sum (step S2). This step is for comprehensively judging the drive load.

The control unit 1 then causes the ambiguity tolerance determination unit 10 to determine a tolerance level for ambiguity in a manual input or voice input depending on the total drive load point (step S3).

Specifically, the ambiguity tolerance determination unit 10, by referring to the required input item determination table 51 (see FIG. 3), may determine the input item that can be omitted, determine a group of words that can be inputted, or determine the voice input time window.

Thereafter, the control unit 1 causes the display control unit 12 to adjust the content of display on the destination setting screen D depending on the total drive load point (step S4).

Specifically, the display control unit 12, by referring to the display condition determination table 52, may determine displayed objects that are toned down or hidden, or modify a displayed message to bring the number of letters in the message window W below a predetermined number.

Thus, the onboard information retrieval apparatus 100 tones down or even hide some displayed objects while maintaining the screen layout in the destination setting screen D, thus preventing the bewilderment on the part of the operator due to a change in screen layout.

Furthermore, the onboard information retrieval apparatus 100 does not change the shape or size of the screen layout or the software buttons, or change the sequence of screen transitions in response to a limitation placed on manual input or voice input. Thus, the operator can be spared of the bewilderment by an unexpected transition to a different screen without notice, for example.

The control unit 1 then stands by until a manual input or a voice input is made (step S5). When either input is made (“YES” in step S5), it is determined whether the required input items have been inputted (step S6). The control unit 1 may determine whether the required input items have been entered by manual input based on the pressing of a separate enter button. The control unit 1 may recognize completion of the input when a predetermined time has elapsed since the manual input of the last text was made.

When it is determined that the required input items have not been entered (“NO” in step S6), the control unit 1 repeats steps S5 and S6. When it is determined that all of the required input items have been entered (“YES” in step S6), the control unit 1 initiates an information search (step S7).

Thus, instead of rejecting all inputs generally so that the driver does not concentrate too much on an operation on the display screen, the onboard information retrieval apparatus 100 maintains an appropriate level of operability by gradually changing the amount of input (For example, the number of letters or the length of voice input time window) depending on the travel environment condition. Thus, improved operator-friendliness can be achieved.

Further, instead of determining whether or not to accept an input on an either-or basis, the onboard information retrieval apparatus 100 controls the limitation on manual input or voice input by gradually changing the amount of such input. Thus, the onboard information retrieval apparatus 100 can prevent inappropriate control such as accepting an input in a travel environment condition when stricter limitations are called for.

### Others

Although this invention has been described in detail with reference to certain embodiments, variations and modifications exist within the scope and spirit of the invention as described and defined in the following claims.

For example, the onboard information retrieval apparatus 100 may be integrated with a navigation apparatus. In this case, based on position information about a destination obtained by a search, routes from the current location to the destination may be retrieved, and a guidance may be immediately started based on the retrieved routes.

The present application is based on the Japanese Priority Application No. 2007-126056 filed May 10, 2007, the entire contents of which are hereby incorporated by reference.

1. An onboard information retrieval apparatus for retrieving information based on a manual input or a voice input made by an operator, comprising:
a travel environment condition detecting unit configured to detect a travel environment condition;
an ambiguity tolerance determination unit configured to determine a tolerance level for ambiguity in the manual input or the voice input, based on the travel environment condition detected by the travel environment detecting unit; and
an information retrieval unit configured to retrieve the information in accordance with the tolerance level determined by the ambiguity tolerance determination unit.

2. The onboard information retrieval apparatus according to claim 1, wherein the ambiguity tolerance determination unit changes the amount of input that can be accepted via the manual input in accordance with the tolerance level determined by the ambiguity tolerance determination unit.

3. The onboard information retrieval apparatus according to claim 1, further comprising a display control unit configured to control the number of letters in a displayed message by modifying the expression of the message.

4. The onboard information retrieval apparatus according to claim 1, further comprising a voice output control unit configured to control the degree of detail or the rate of output of a voice guidance based on the travel environment condition detected by the travel environment condition detecting unit.

5. The onboard information retrieval apparatus according to claim 1, wherein the travel environment condition detecting unit detects the travel environment condition based on a vehicle speed, the time of day, an inter-vehicle distance, weather, or driver's biological information.

6. The onboard information retrieval apparatus according to claim 1, wherein the ambiguity tolerance determination unit determines the tolerance level for ambiguity in the manual input and the tolerance level for ambiguity in the voice input separately.
